(19) United States
(12) Patent Application Publication
(10) Pub. No.: US 2023/0038620 A1
(43) Pub. Date: Feb. 9, 2023

(54) METHOD OF SETTING USER-DEFINED VIRTUAL NETWORK

(71) Applicant: ELECTRONICS AND TELECOMMUNICATIONS RESEARCH INSTITUTE, Daejeon (KR)

(72) Inventors: Sun Cheul KIM, Daejeon (KR); Tae Yeon KIM, Daejeon (KR); Ho Yong RYU, Daejeon (KR)

(73) Assignee: ELECTRONICS AND TELECOMMUNICATIONS RESEARCH INSTITUTE, Daejeon (KR)

(21) Appl. No.: 17/511,767

(22) Filed: Oct. 27, 2021

(30) Foreign Application Priority Data
Aug. 5, 2021 (KR) 10-2021-0103448

(51) Int. Cl. H04L 61/2521; H04L 61/256; H04L 12/46; H04L 45/586

(52) U.S. Cl. CPC H04L 61/2525; H04L 61/256; H04L 12/4633; H04L 45/586

(57) ABSTRACT

A method of setting a user-defined virtual network is disclosed. A method of setting a virtual network includes configuring a virtual network including a controller, at least one network address translation (NAT) and at least one edge node, checking an operation type of the at least one edge node, setting a tunnel between the at least one edge node based on the operation type, and performing data transmission between the at least one edge node through the set tunnel.

### CROSS REFERENCE TO RELATED APPLICATION

The present application claims priority to a K.R. application 10-2021-0103448, filed Aug. 5, 2021, the entire contents of which are incorporated herein for all purposes by this reference.

### TECHNICAL FIELD

The present disclosure relates to virtualization technology and, more particularly, to technology for configuring and setting a virtual network.

### BACKGROUND ART

Recently, software-defined wide-area network (SD-WAN) technology has been introduced to upgrade an enterprise network. SD-WAN enables safe and intelligent transmission of traffic between edge nodes located at the end of a WAN section by applying a centralized control function. This improves application performance and provides a high-quality user experience, thereby increasing business productivity and agility and reducing network construction cost.

The edge node of a conventional SD-WAN is located at an entry point of an enterprise network to configure a local area network (LAN) and to serve to connect LANs between headquarters and branches like a conventional virtual private network (VPN).

### DISCLOSURE

### Technical Problem

In general, in each edge node, a public IP is used without considering network address translation (NAT) and firewalls. Accordingly, it is impossible to apply edge nodes to an Internet router, an access point, a host device, a virtual machine (VM) or a container, which are close to an end user or service.

An object of the present disclosure is to provide a method and apparatus for realizing network virtualization by setting an edge node at a location closer to a user and service rather than a conventional network center.

An object of the present disclosure is to provide a method and apparatus for setting an edge node in an Internet router, an access point, a host device, a VM or a container close to an end user and service.

The technical problems solved by the present disclosure are not limited to the above technical problems and other technical problems which are not described herein will become apparent to those skilled in the art from the following description.

### Technical Solution

According to an embodiment of the present disclosure, a method of setting a user-defined virtual network is provided. The method includes configuring a virtual network including a controller, at least one network address translation (NAT) and at least one edge node, checking an operation type of the at least one edge node, setting a tunnel between the at least one edge node based on the operation type, and performing data transmission between the at least one edge node through the set tunnel.

The features briefly summarized above with respect to the present disclosure are merely exemplary aspects of the detailed description below of the present disclosure, and do not limit the scope of the present disclosure.

### Effects of Invention

According to the present disclosure, since a “direct Tunnel” or “Detour Tunnel” can be set according to a connection condition between edge nodes and connectivity is provided based on tunneling, it is possible to realize direct communication between all services or devices respectively connected to the edge nodes.

According to the present disclosure, control messages transmitted and received between a controller and an edge and between an edge node and an edge node and IP-UDP-IP tunnel based data channels between an edge node and an edge node can support an AES encryption/decryption function and realize encryption for all application services operating in an edge node included in a corresponding virtual network.

According to the present disclosure, it is possible to set not only a gateway configuring a LAN but also an access point and end point device configuring a Wi-Fi network, that is, a host device, a virtual machine (VM) or a container, as an edge node.

According to the present disclosure, it is possible to measure and monitor quality of a control channel, system resources of an edge node and quality of a data channel between edge nodes, by connecting a central orchestrator and controller and each edge node.

### DESCRIPTION OF DRAWINGS

FIG. 1 is a view illustrating an SD-WAN architecture, to which a virtual network according to an embodiment of the present disclosure applies.

FIG. 2 is a view illustrating the structure of a firewall and an internal network in a general network environment.

FIG. 3 is a view illustrating operation of network address translation (NAT) in a general network environment.

FIG. 4 is a view illustrating a structure of server virtualization, to which a virtual network according to an embodiment of the present disclosure applies.

FIG. 5 is a view illustrating the concept of a virtual network according to an embodiment of the present disclosure.

FIG. 6 is a view illustrating an example of a virtual network structure according to an embodiment of the present disclosure.

FIG. 7 is a view illustrating another example of a virtual network structure according to an embodiment of the present disclosure.

FIG. 8 is a view illustrating another example of a virtual network structure according to an embodiment of the present disclosure.

FIG. 9 is a view illustrating an example of an overlay tunnel interface structure used in a virtual network according to an embodiment of the present disclosure.

FIG. 10 is a view illustrating an example of a structure of a tunneling packet used in FIG. 9.

FIGS. 11A and 11B are views illustrating types of tunneling used in a virtual network according to an embodiment of the present disclosure.

FIG. 12 is a view illustrating a NAT operation procedure used in a virtual network according to an embodiment of the present disclosure.

FIGS. 13A to 13C are views illustrating information exchanged and managed in NAT traversal operation of FIG. 12.

FIG. 14 is a view illustrating a procedure for determining an operation type in a virtual network according to an embodiment of the present disclosure.

FIG. 15 is a view illustrating a procedure for processing UDP hole punching in a virtual network according to an embodiment of the present disclosure.

FIGS. 16A and 16B are view illustrating an example of a tunnel table used in a direct tunnel set by FIG. 15.

FIG. 17 is a view illustrating a detour tunnel setting procedure in a virtual network according to an embodiment of the present disclosure.

FIGS. 18A to 18C are views illustrating an example of a tunnel table used in the detour tunnel of FIG. 17.

FIG. 19 is a view illustrating a virtual IP block assignment structure in a virtual network according to an embodiment of the present disclosure.

FIG. 20 is a view illustrating a control structure of a virtual network according to an embodiment of the present disclosure.

FIGS. 21A to 21K are views illustrating a control structure of a virtual network according to an embodiment of the present disclosure.

FIG. 22A is a view illustrating encrypted tunneling in a virtual network according to an embodiment of the present disclosure.

FIG. 22B is a view illustrating a virtual network structure according to an embodiment of the present disclosure.

FIG. 22C is a view illustrating an environment, to which a virtual network according to an embodiment of the present disclosure applies.

### MODE FOR INVENTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

Hereinafter, embodiments of the present disclosure will be described with reference to the accompanying drawings.

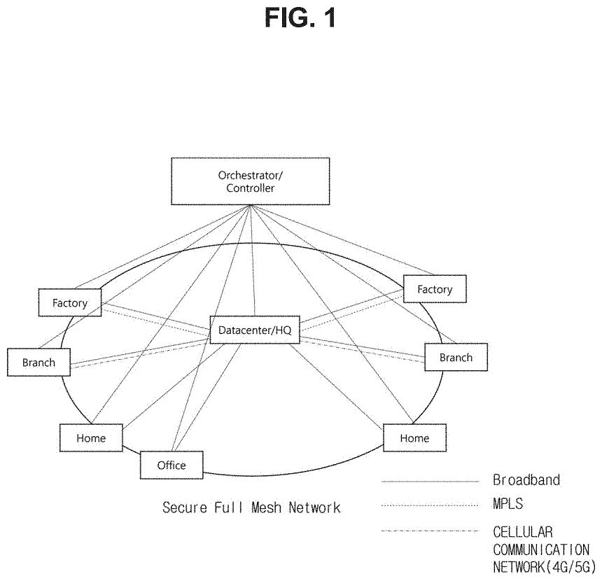

FIG. 1 is a view illustrating an SD-WAN architecture, to which a virtual network according to an embodiment of the present disclosure applies.

SD-WAN may include an orchestrator, a controller and edge nodes. The orchestrator and the controller may be located in a center or may be located in distributed branches.

The orchestrator and the controller may control the edge nodes through a “Secure Control Channel”, and the edge nodes may configure a “Secure Full Mesh Network” through a communication network such as “Broadband” or “4G LTE/5G”. The edge nodes may be located in any space requiring a network “Branch”, “Factory”, “Home” or “Office”. Since each edge node provides mutual direct communication, it is possible to minimize a backhaul to a hub or headquarter data center according to the application policy and to directly transmit and receive traffic through the “Secure Full Mesh Network”.

In addition, in the present disclosure, an IP-UDP-IP tunnel, to which “NAT Traversal” and “UDP Hole Punching” apply, is used to overcome a firewall or NAT environment, and the topology of each edge node is defined by a user to generate a virtual network and to provide encryption functions for transmitted and received control channels and data channels. In particular, the edge node may be not only a network device (router or switch) having a wired LAN but also a network device (access point) having a wireless LAN or a host, VM, container as an end point. Such a virtual network is centrally managed and includes a monitoring function to operational convenience.

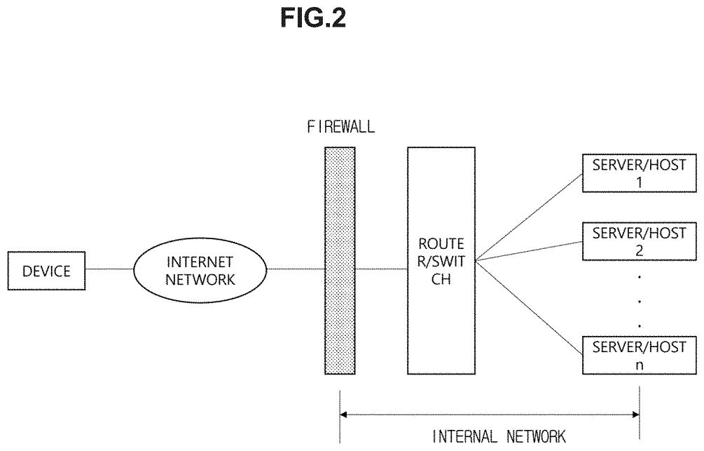

FIG. 2 is a view illustrating the structure of a firewall and an internal network in a general network environment.

In a network environment, there may be a limitation in a firewall or NAT. In general, the firewall is used to block access from an external network (e.g., the Internet) to protect a specific network, and NAT is used to use a private IP due to lack of public IP. The firewall may be installed in a network section with a different trust level to prevent traffic flowing from a network section with a low trust level to a network section with a high trust level. From the viewpoint of a network administrator, a section with high reliability may be referred to as an internal network section and a section with low reliability may be referred to as an Internet section or an external network section.

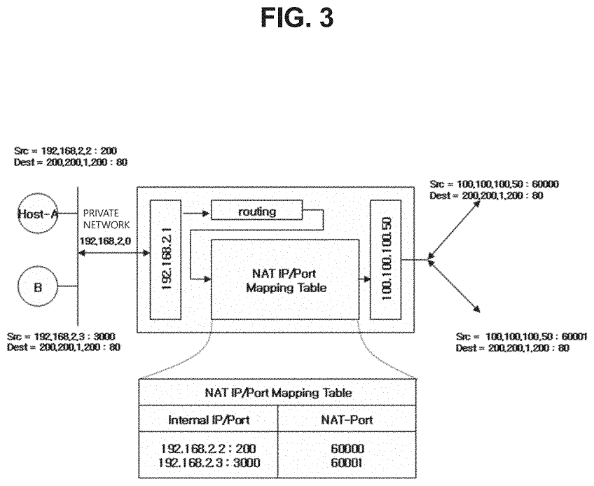

FIG. 3 is a view illustrating operation of network address translation (NAT) in a general network environment.

When terminals access a network, an assigned public IP or a private IP received from NAT may be used. In case of using NAT, SNAT used to solve insufficient IP or DNAT, which places a server to be operated inside a specific private network and allows access of only a specific user who knows it, is used. Such NAT enables communication, by connecting a public IP assigned from an ISP to an external network, assigning a private IP to each terminal connected to the NAT, and maintaining mapping information between the private IP/port and the IP/port of an external network. A typical example thereof includes an access point installed and used at home. NAT allows a user to simultaneously connect terminals Host-A and Host-B located in a private network thereof composed of 192.168.2.0 to an external network using 100.100.100.50 which is a public IP assigned from the ISP. To this end, when an NAT router which has received an IP packet transmitted from the terminal A and the terminal B, which have set the NAT router as a default gateway, to an external network is aware of the fact that a destination is in the external network by a routing function, the IP and port number of a transmission terminal is recorded in the mapping table. Thereafter, the IP address and port number of the transmission side of this packet are updated to 100.100.100.50 which is a public IP address and a new port number of 60000 or more (which differs between devices) and is transmitted to the ISP. The router of the ISP which has received this packet regards these packets as packets transmitted by the same terminal of 100.100.100.50 in two different processes and thus may transmit it to the other Internet without any problem. In addition, for all packets received from the ISP, since the NAT router may find and transmit the IP address and port number to the terminal by referring to the previously recorded port number and internal network address mapping table, several terminals may use a public network by sharing one IP address provided by the ISP.

Currently, as virtualization technology is developed, a degree of completion of technologies for efficiently using server resources or network resources by installing a plurality of virtual machines inside a server while a physical server is used as a virtualization server rather than being operated as one server.

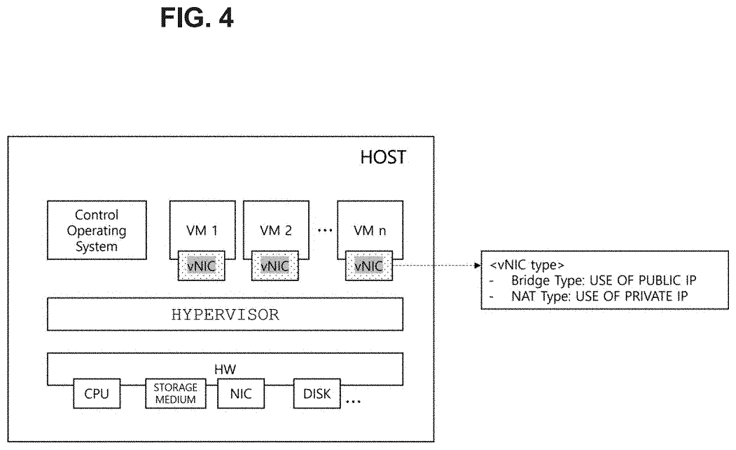

FIG. 4 is a view illustrating a structure of server virtualization, to which a virtual network according to an embodiment of the present disclosure applies.

A host may include hardware resources (e.g., CPU, Memory, NIC (Network Interface Card), Disk, etc.) and a hypervisor. The hardware resources may be shared among virtual machines through the hypervisor. In particular, in an embodiment of the present disclosure, a virtual NIC may be configured inside a virtual machine. The vNIC may include a bridge mode using a public IP and an NAT mode using a private IP. In the bridge mode, the vNIC may be directly accessed from outside and, in the NAT mode, vNIC may not be directly accessed from outside. This is possible because the hypervisor of the host assigns the public IP in the bridge mode and assigns the private IP in the NAT node. Accordingly, when the NAT mode is used, the host may set a port forwarding (DNAT) policy in the host and perform communication through a VM.

SD-WAN is technology for providing connectivity to an enterprise network and is used as a replacement for VPN. However, SD-WAN is configured to be located at an entry point of the enterprise network and may be network centric technology.

An embodiment of the present disclosure provides a method and apparatus capable of implementing an edge node at a location closer to a user and service in existing network-centric technology. To this end, each edge node may be configured to perform a “NAT Traversal” or “UDP Hole Punching” function to overcome limitations of the NAT and firewall.

In addition, an embodiment of the present disclosure provides a method and apparatus for enabling a user to define a virtual network and setting a topology of an edge node in connection with a central orchestrator, a controller and an edge node.

In particular, in an embodiment of the present disclosure, it is possible to set not only a gateway configuring a LAN but also an access point or an end point configuring a Wi-Fi network, such as a host, VM, container, etc., as an edge node.

In addition, in an embodiment of the present disclosure, it is possible to measure and monitor quality of a control channel and to measure and monitor quality of a data channel between edge nodes, by connecting a central orchestrator and controller and an edge node.

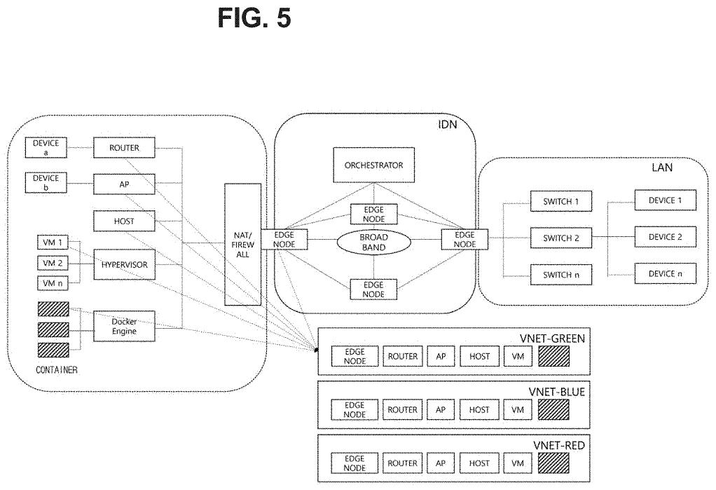

FIG. 5 is a view illustrating the concept of a virtual network according to an embodiment of the present disclosure.

Referring to FIG. 5, the virtual network may include an orchestrator and at least one edge node.

The orchestrator may include a UI/UX management unit for managing a user interface for user registration or deletion, virtual network registration or deletion or edge node registration or deletion. The user interface for user registration or deletion, virtual network registration or deletion or edge node registration or deletion provided by the UI/UX management unit will be described in detail with reference to the following drawings. Furthermore, the user may use the user interface provided by the UI/UX management unit and register an edge node in a virtual network, and, based on this, the orchestrator may establish a virtual network, such as “VNET-GREEN”, “VNET-BLUE” or “VNET-RED”, including the registered edge node.

In addition, the orchestrator may include a controller which performs a “NAT/Traversal” function in connection with an edge node and distributes information on other edge nodes in the virtual network.

The edge node may include a gateway node functioning as a gateway of a wired/wireless LAN environment, a router node functioning as an Internet router, an AP node functioning as an access point, a VM node functioning as a VM and a container node functioning as a container.

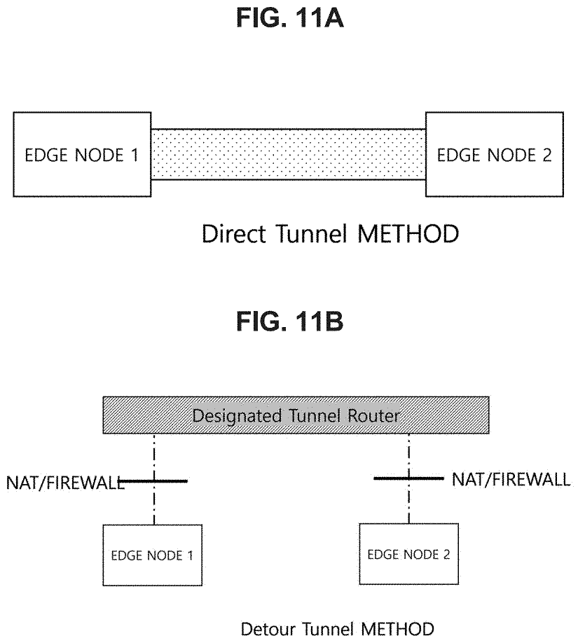

The edge node may establish an IP-UDP-IP tunnel to the corresponding edge node, by performing a “UDP Hole Punching” function based on “NAT Traversal” information of another edge node. In this case, the IP-UDP-IP tunnel may be set as a “Direct Tunnel” or “Detour Tunnel”. A connection method of the “Direct Tunnel” and “Detour Tunnel” will be described with reference to FIGS. 11a and 11b.

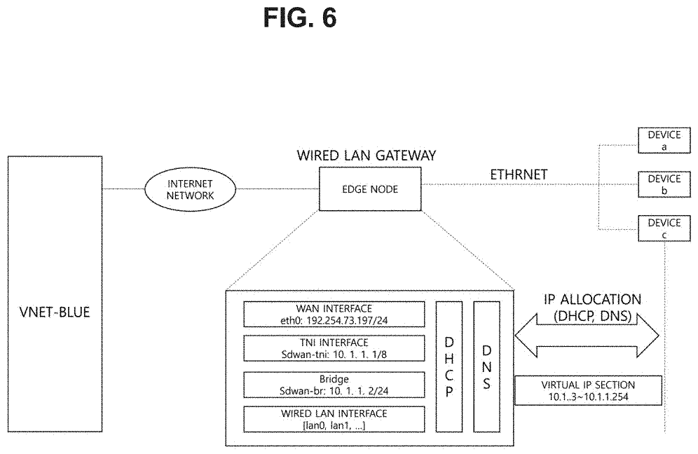

FIG. 6 is a view illustrating an example of a virtual network structure according to an embodiment of the present disclosure.

Referring to FIG. 6, in an embodiment of the present disclosure, an edge node may include a node functioning as a gateway having a LAN.

The edge node may include an Internet router which is located at an entry point of an enterprise or located in an office or home. The edge node performs a “NAT Traversal” with the controller and performs a “UDP Hole Punching” with the edge node to set a “Direct Tunnel” or “Detour Tunnel”. In addition, after a plurality of LAN interfaces is connected to a bridge, a DHCP service function may be added to the bridge and an IP automatic assignment function may be performed with respect to the connected terminal. The edge node may generate a TNI and bridge interface as a virtual interface based on a virtual IP block assigned from the controller and connect the plurality of LAN interfaces to the bridge interface.

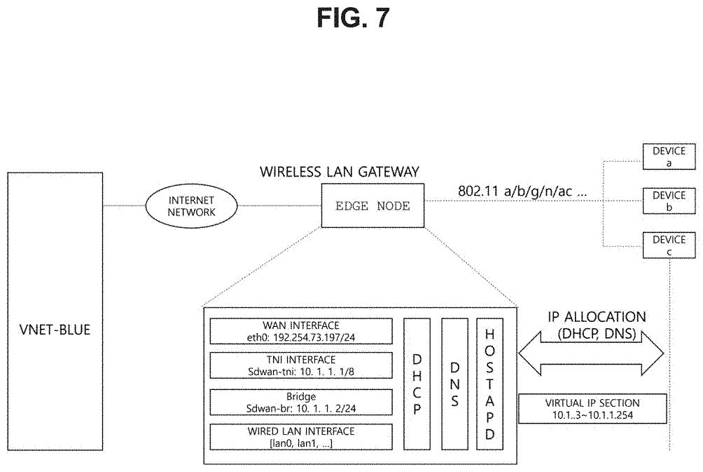

FIG. 7 is a view illustrating another example of a virtual network structure according to an embodiment of the present disclosure.

Referring to FIG. 7, in an embodiment of the present disclosure, an edge node may include a node functioning as a gateway having a wireless LAN.

The edge node may include an access point located in an office or home. The edge node may perform “NAT Traversal” function, a “UDP Hole Punching” function, and a “DHCP” process, and may additionally perform functions such as radio signal transmission and authentication. The edge node may generate TNI and bridge interfaces as a virtual interface based on a virtual IP block assigned from the controller and connect the wireless LAN interface to the bridge interface.

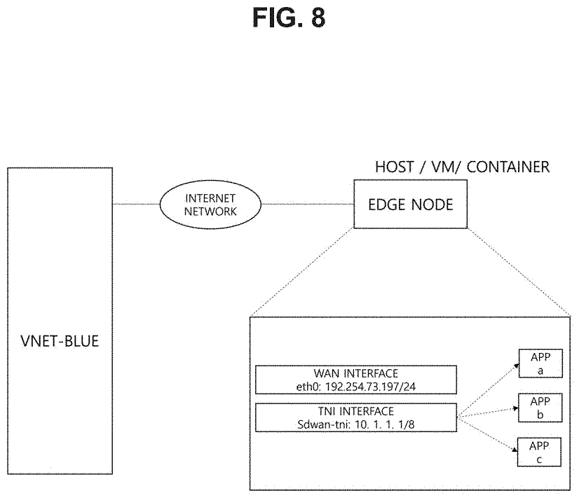

FIG. 8 is a view illustrating another example of a virtual network structure according to an embodiment of the present disclosure.

Referring to FIG. 8, in an embodiment of the present disclosure, an edge node may include one of a host device, a virtual machine (VM) or a container.

The edge node may perform a “NAT Traversal” function and a “UDP Hole Punching” function, and generate TNI as a virtual interface based on a virtual IP assigned from the controller. In addition, the edge node may perform communication with another edge node through the TNI.

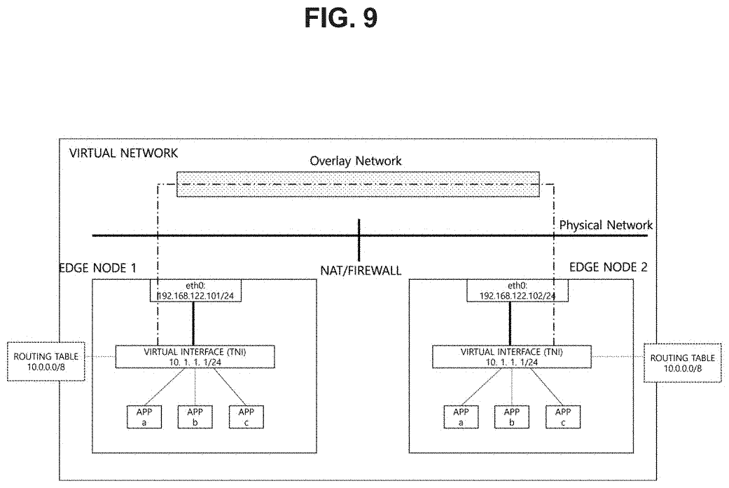

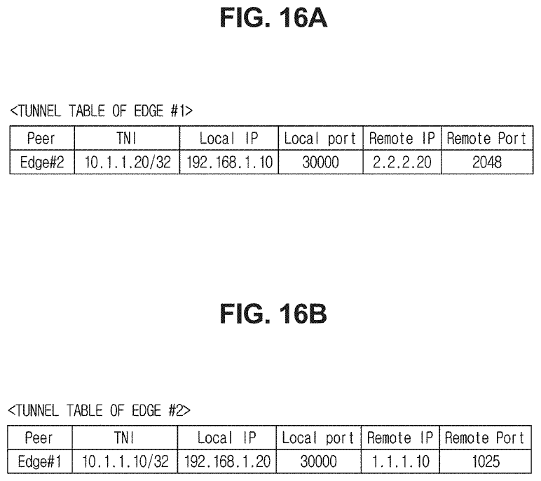

A method of performing communication by the edge node through the TNI will be described in detail with reference to FIGS. 9 to 18.

FIG. 9 is a view illustrating an example of an overlay tunnel interface structure used in a virtual network according to an embodiment of the present disclosure.

Referring to FIG. 9, an edge node may set a TNI and set a destination of a virtual network address as a virtual interface. In this environment, the edge node may perform encapsulation/decapsulation of a tunnel header in an S/W tunneling mode to check a tunneling table and enable communication between edge nodes in a virtual network through a transmission/reception function.

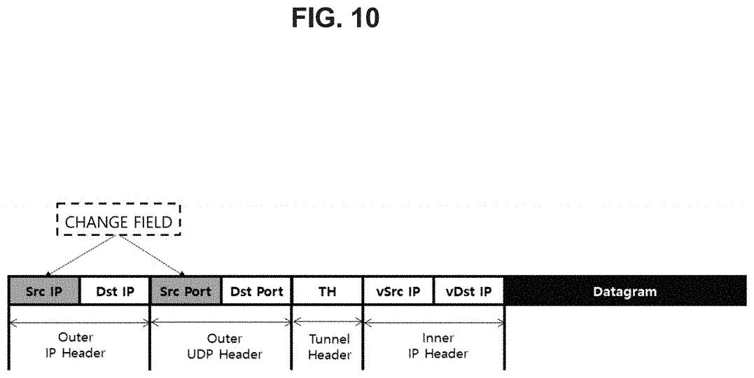

FIG. 10 is a view illustrating an example of a structure of a tunneling packet used in FIG. 9.

Specifically, FIG. 10 shows a structure of a tunneling packet applying to an overlay tunnel network.

The tunneling packet may include an outer IP header, an outer UDP header, a tunnel header, an inner IP header, and a data field. Here, the outer IP Header and the outer UDP Header include information on a source IP and a source port determined by “NAT Traversal”. The inner IP header may include information on a virtual IP set by a user through a user interface and may be assigned from a controller as an edge node is connected. The tunnel header may be used as an identifier for identifying a control packet and a tunnel packet. Furthermore, the tunnel header may be used as an identifier for identifying a packet, such as QoS.

FIGS. 11a and 11b are views illustrating types of tunneling used in a virtual network according to an embodiment of the present disclosure.

Referring to FIG. 11a, a “Direct Tunnel” may be refer to a method of performing communication by setting a direct tunnel between edge nodes. Referring to FIG. 11b, a “Detour Tunnel” may refer to a method of setting a tunnel to a “Designated Tunnel Router” and performing communication between edge nodes through the “Designated Tunnel Router”.

In a virtual network setting process, when edge nodes succeed in “UDP Hole Punching”, the edge nodes may perform communication by setting the “Direct Tunnel” and, in case of failure, the edge nodes may perform communication by setting the “Detour Tunnel”.

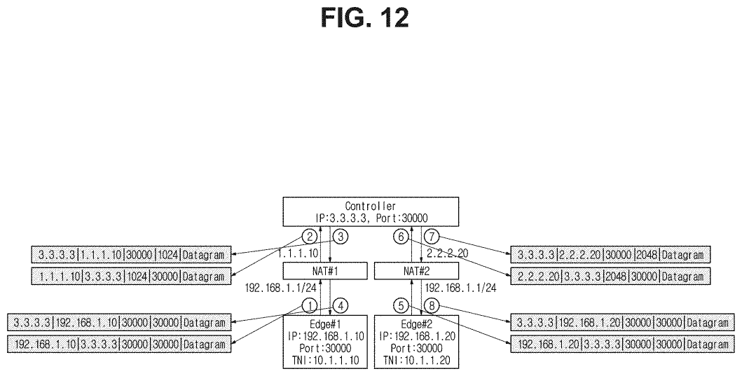

FIG. 12 is a view illustrating a NAT operation procedure used in a virtual network according to an embodiment of the present disclosure.

First, a controller and an edge node exchange control messages, extract IP information and port information converted by NAT, and distribute them (IP information and port information) to the edge node of the virtual network. Hereinafter, this operation is referred to as “NAT Traversal operation”.

In NAT Traversal operation, when a public network and a firewall are connected, IP information is not changed. For example, as shown in FIG. 12, the source IP and the source port may be changed to 1.1.1.10 and 1024 while passing through a first NAT 1201 and the source IP and the source port may be changed to 2.2.2.20 and 2048 while passing through a second NAT 1202.

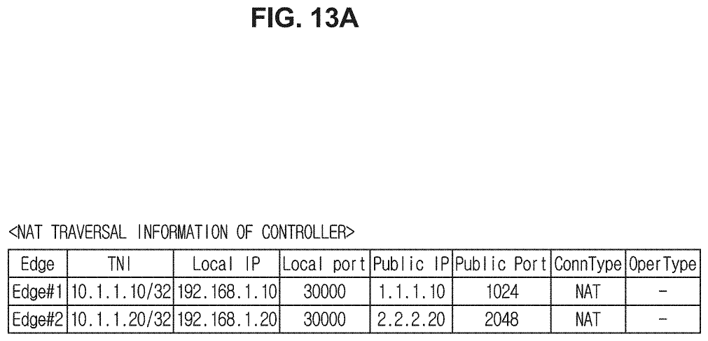

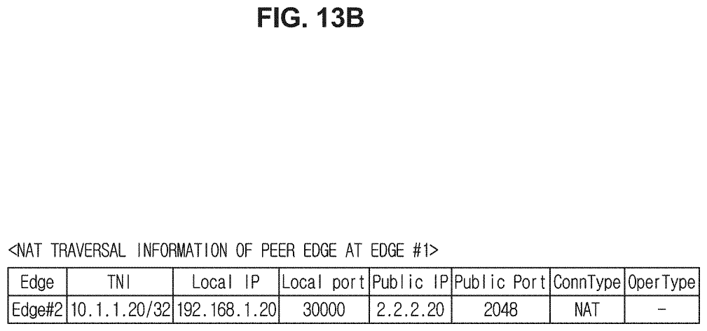

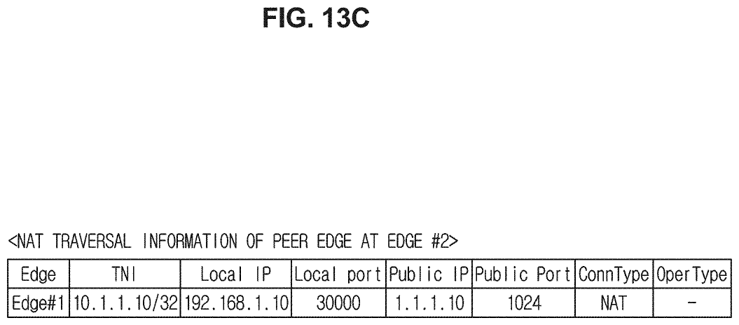

FIGS. 13a to 13c are views illustrating information exchanged and managed in NAT traversal operation of FIG. 12. Specifically, FIG. 13a shows NAT Traversal information managed by a controller, FIG. 13b shows NAT Traversal information managed by a first edge node, and FIG. 13c shows NAT Traversal information managed by a second edge node.

The NAT Traversal information managed by the controller may include information on a TNI, a local IP, a local port, a public IP, a public port, a connection type and an operation type. Here, the local IP information and port information may mean IP information and port information set in the WAN interface of the edge node, and the public IP information and port information means source IP information and port information of an IP header in terms of the controller. Accordingly, the edge node connected to the NAT may change local IP information and port information and public IP information and port. The connection type indicates a connection type between the edge node and the network and may be set to “Public” or “NAT”. The operation type may represent a type of connectivity of the connected network and may include “Open” and “Restrict”.

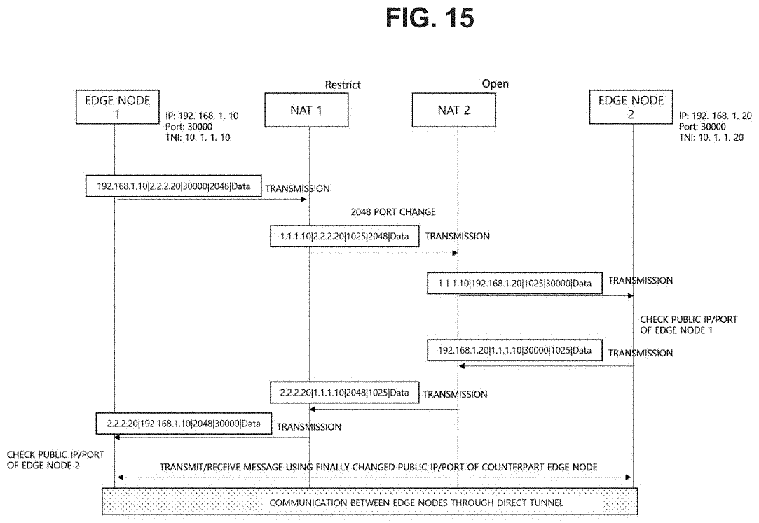

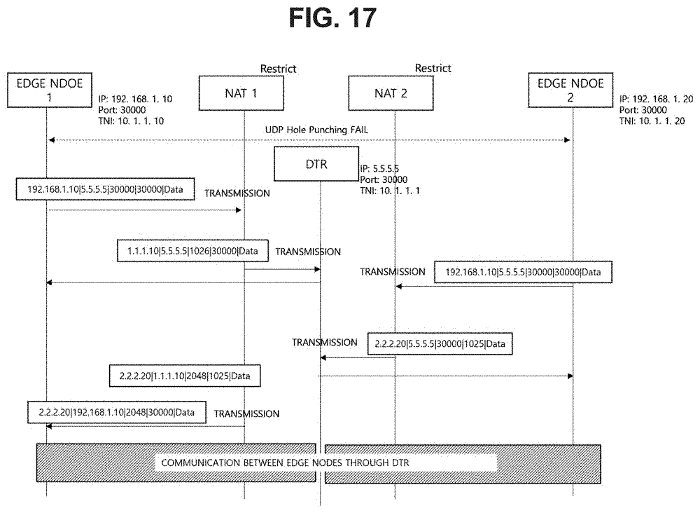

Furthermore, the controller may determine the operation type according to success or failure of “UDP Hole Punching”. For example, the controller may check success or failure of “UDP Hole Punching” through operation shown in FIGS. 15 and 17.

As described above, the controller may check NAT Traversal information of a first edge node and a second edge node and respectively provide them to the first edge node and the second edge node. In response thereto, the first edge node may store and manage NAT Traversal information shown in FIG. 13b. The second edge node may store and manage NAT Traversal information shown in FIG. 13c.

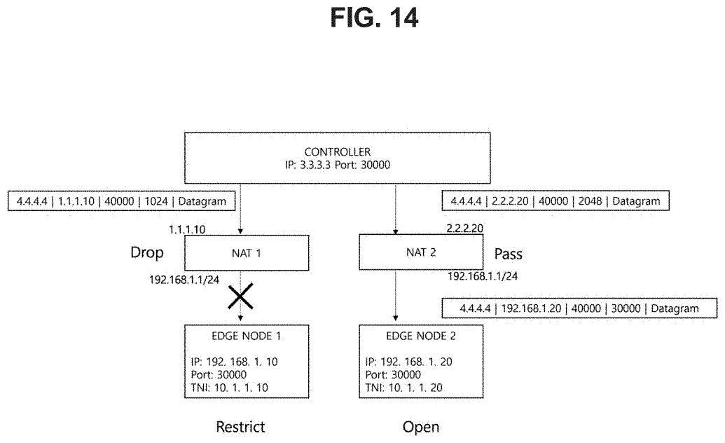

FIG. 14 is a view illustrating a procedure for determining an operation type in a virtual network according to an embodiment of the present disclosure.

Referring to FIG. 14, a controller may configure IP information and port information composed of information different from IP information and port information set thereto and sets them as the source IP and source port of the IP header, in order to determine the operation type. In addition, the controller configures a control message including the above-described IP header and transmits it to each node. Thereafter, the controller may determine an operation type depending on whether each edge node receives a control message including the IP header. For example, the controller may determine the operation type to be “Open” when the edge node receives the control message and determine the operation type to be “Restrict” when the edge node does not receive the control message.

When the controller configures and transmits the control message using the above-described method, it is possible to check the operation type (“Open” or “Restrict”) by relatively simple operation, without the need to perform a complicated STUN process.

For example, referring to FIG. 14, for example, the controller sets 4.4.4.4 and 40000 as the source IP and source port of the IP header instead of 3.3.3.3 and 30000 set thereto. In addition, the controller configures a control message including the above-described IP header and transmits it to the first and second edge nodes. In response thereto, a first NAT connected to the first edge node does not allow an IP header composed of 4.4.4.4 and 40000, and does not provide the control message to the first edge node. In contrast, a second NAT connected to the second edge node allows an IP header composed of 4.4.4.4 and 40000 and provides the control message to the second edge node. Accordingly, the controller may determine the operation type to be “Restrict” for the first edge node and determine the operation type to be “Open” for the second edge node. Thereafter, the controller may include the operation type of the edge node (e.g., the first edge node, the second edge node, etc.) in NAT Traversal information, and the recorded operation type information may be provided to the edge node (the first edge node, the second edge node, etc.).

The first edge node is connected through the first NAT of “Restrict” type and thus cannot perform direct communication, and the second edge node is connected through the second NAT, but can perform direct communication because the second NAT is of an open type. In connection of the edge node, when one edge node is of “Open” type, direct communication is possible through “UDP Hole Punching”. Accordingly, the edge node may set the “Direct Tunnel” using operation type information.

FIG. 15 is a view illustrating a procedure for processing UDP hole punching in a virtual network according to an embodiment of the present disclosure.

In FIG. 15, a virtual network may include a first edge node, a first NAT connected to the first edge node, a second edge node and a second NAT connected to the second edge node.

UDP hole Punching operation may be performed after the above-described operation type checking operation of 14 is completed. In an embodiment of the present disclosure, it is assumed that the first NAT is of “Restrict” operation type and the second NAT is of “Open” operation type.

The first edge node and the second edge node may include and manage operation type information in NAT Traversal information.

The edge node (e.g., the first edge node) set to a “Restrict” type may check operation type information of a counterpart edge node (e.g., the second edge node), and transmit a Udp Hole Punching message to the edge node (e.g., the second edge node) when the operation type of the counterpart edge node (e.g., the second edge node) is “Open”. In this case, the Udp Hole Punching message may include an IP header, and the first edge node may perform transmission and reception by setting a Destination IP and Port of the IP header to a Public IP and Port by NAT Traversal. The packet of the “Udp Hole Punching message” transmitted by the first edge node is transmitted to the first NAT of the “Restrict” operation type and the first NAT changes and transmits a Public Port value. Since the second NAT is of an “Open” operation type, the packet may be transmitted to the second edge node. The second edge node may change the Source IP and Source Port of the “Udp Hole Punching message” to a Destination IP and Destination Port and transmit them to the first edge node. Thereafter, the second edge node may periodically transmit and receive the message using the changed IP and Port value as a destination. Through this operation, when “UDP Hole Punching” setting succeeds, the second edge node may set a “Direct” tunnel with the changed IP and Port as a destination and configure a communication channel between the virtual IP “10.1.1.10” of the first edge node and the virtual IP “10.1.1.20” of the second edge node.

FIG. 17 is a view illustrating a detour tunnel setting procedure in a virtual network according to an embodiment of the present disclosure.

Referring to FIG. 17, when the “UDP Hole Punching” procedure fails, since a direct tunnel between edge nodes cannot be set, each edge node may set tunnel information to a counterpart edge node to “DTR” located in a cloud or public network and, through it, perform communication using a virtual IP of each edge node.

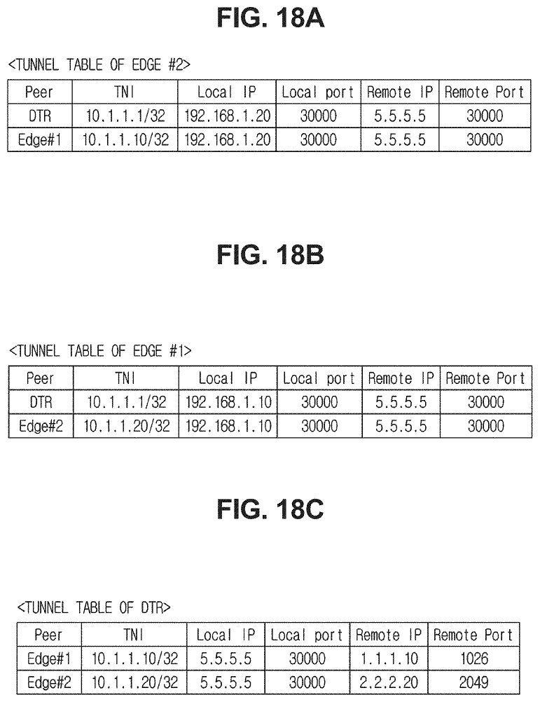

The first edge node transmits and receives a message to the DTR through the first NAT, and the second edge node transmits and receives a message to the DTR through the second NAT. In this case, the first edge node may store and manage a first tunnel table shown in FIG. 18a, and the second edge node may store and manage a second tunnel table shown in FIG. 18b. The first edge node and the second edge node may respectively use the first and second tunnel tables to transmit and receive the messages to from the DTR.

Meanwhile, the DTR may set tunnel information using the changed Public IP and Port based on the edge nodes and NAT Traversal information. Thereafter, the first edge node and the second edge node may perform communication through the DTR. In this case, the DTR may store and manage a DTR tunnel table shown in FIG. 18c.

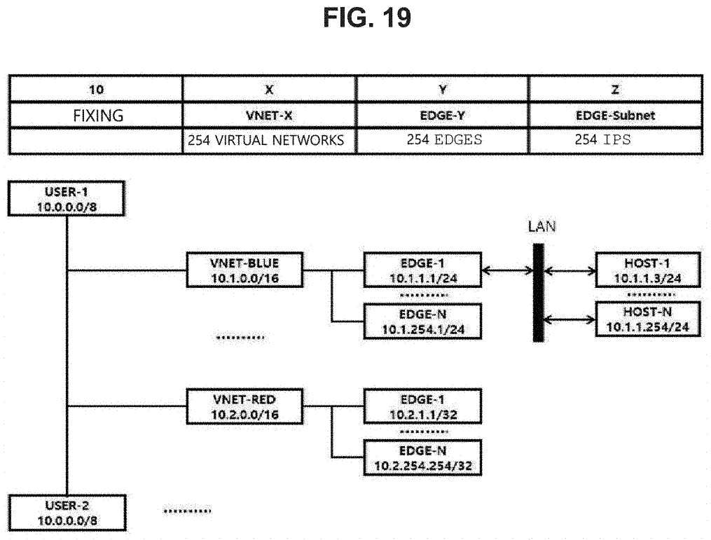

FIG. 19 is a view illustrating a virtual IP block assignment structure in a virtual network according to an embodiment of the present disclosure.

FIG. 19 shows a structure of a virtual network address and prefix length assigned to a user, a virtual network and each edge node. An IP address system may be managed by an Internet assigned numbers authority (IANA), a virtual network address used in an embodiment of the present disclosure is selected within 10.0.0.0/8 allowed to be used independently, and the assigned IP and prefix length are set in the TNI of the edge node. The user may generate a plurality of virtual networks, designate a virtual IP block for each virtual network, and register a plurality of edge nodes in the virtual network. A virtual IP block or virtual IP may be assigned to the corresponding edge node. The edge node having the virtual IP block may be a network gateway having a LAN, and the virtual IP may be assigned to an edge node, such as a host, a VM or a container, as an end point.

For example, “10.0.0.0/8” is assigned when “USER-1” is registered, and “USER-1” assigns “10.1.0.0/16” when a virtual network “VNET-BLUE” is registered and registers “10.1.1.1/24” when “EDGE-1” is registered in “VNET-BLUE”. It is assumed that a virtual IP block assigned to a virtual network is assigned as “10.1.0.0/16 to 10.254.0.0/16”, and a virtual IP block assigned to an edge node may be assigned as “10.1.1.0/24 to 10.1.254.0/24”. Accordingly, virtual IPs of “10.1.1.2 to 10.1.1.254” may be assigned to network devices accessing “EDGE-1”. An edge node without a LAN, that is, an edge node operating as an End Point, may be assigned a Full Mask like “10.2.1.1/32” as in EDGE-1 of “VNET-RED”. A method of registering a new user “USER-2” and assigning it to a virtual network and edge node is equally applicable.

Although, in an embodiment of the present disclosure, a method of assigning a virtual IP address block is shown, the present disclosure is not limited thereto and the method of assigning the virtual IP address block may be variously changed according to individual policies.

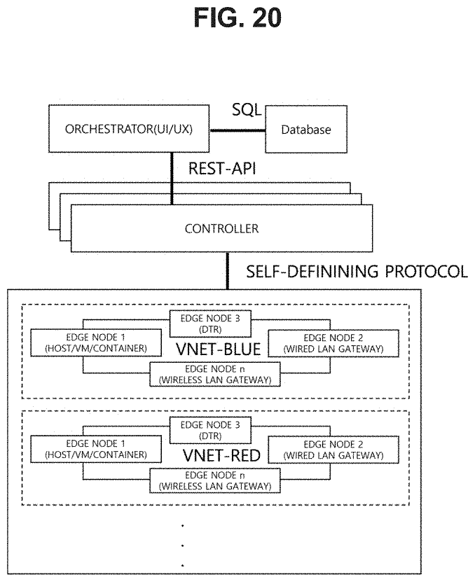

FIG. 20 is a view illustrating a control structure of a virtual network according to an embodiment of the present disclosure.

Referring to FIG. 20, the virtual network may include an orchestrator, a controller and at least one edge node.

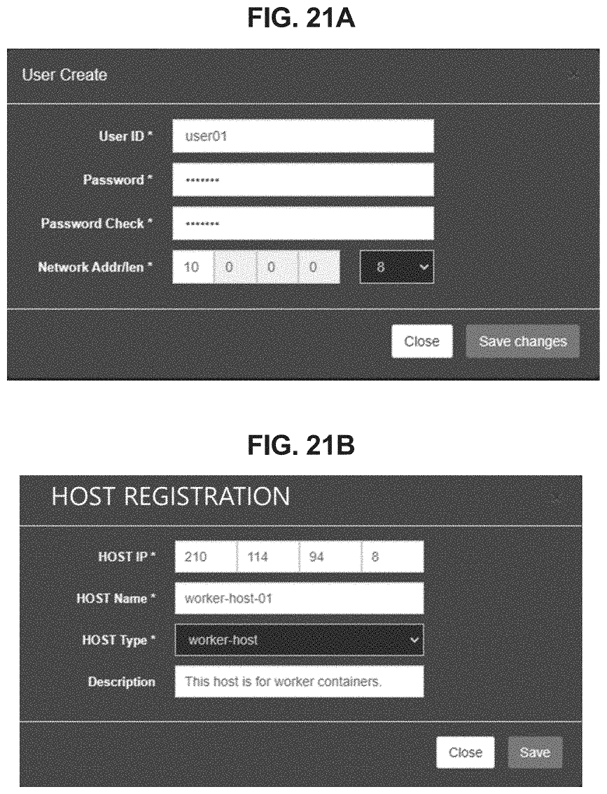

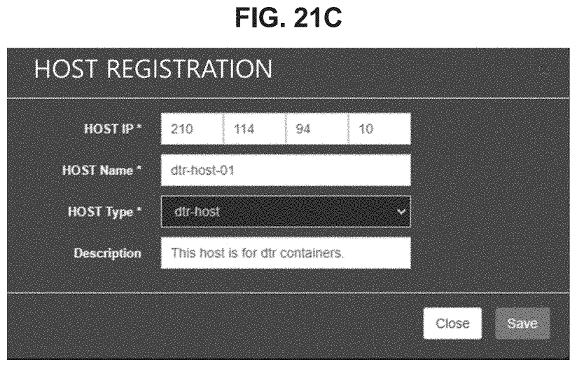

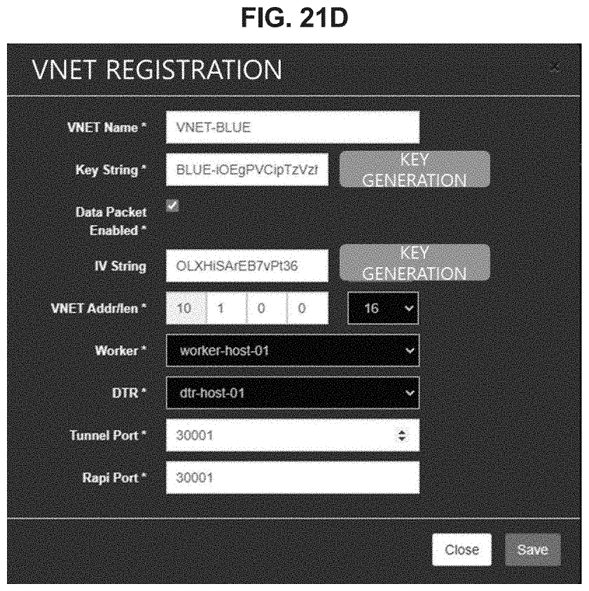

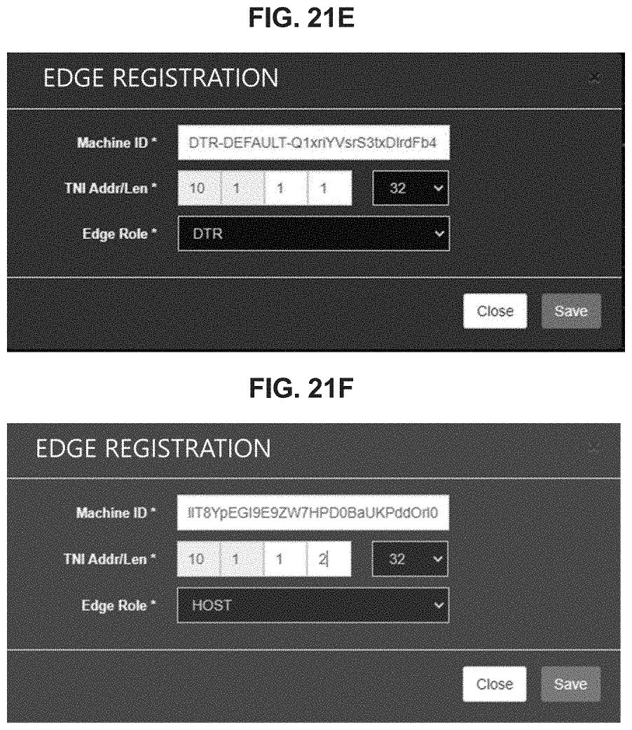

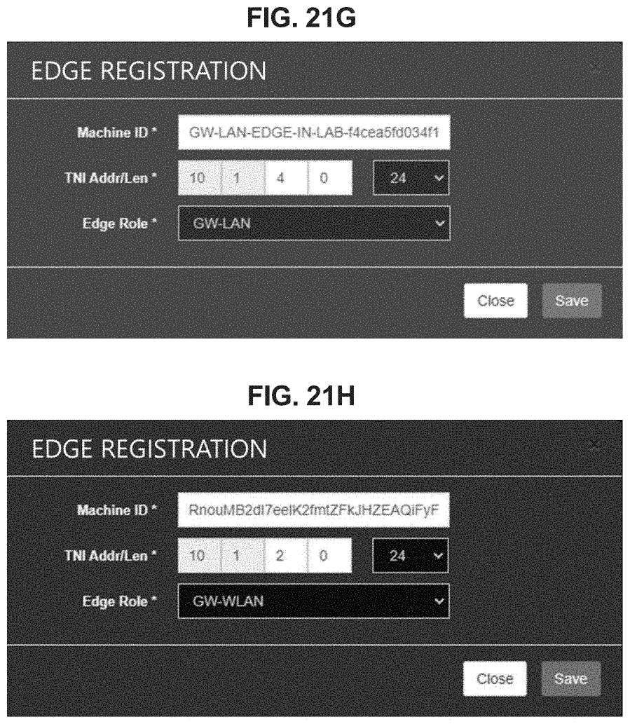

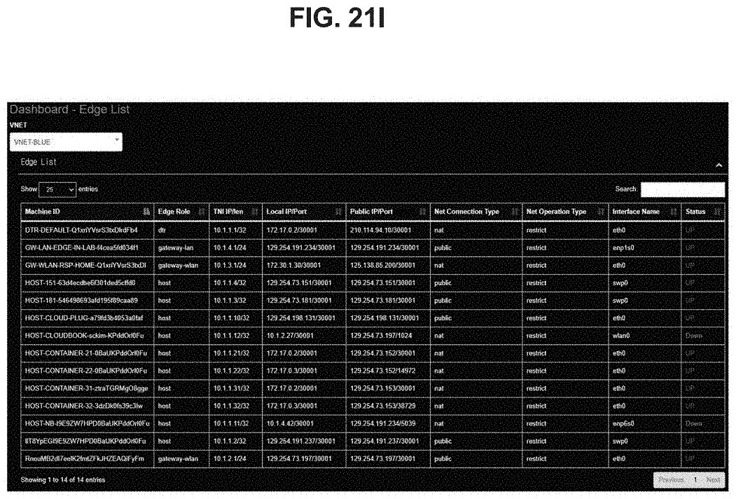

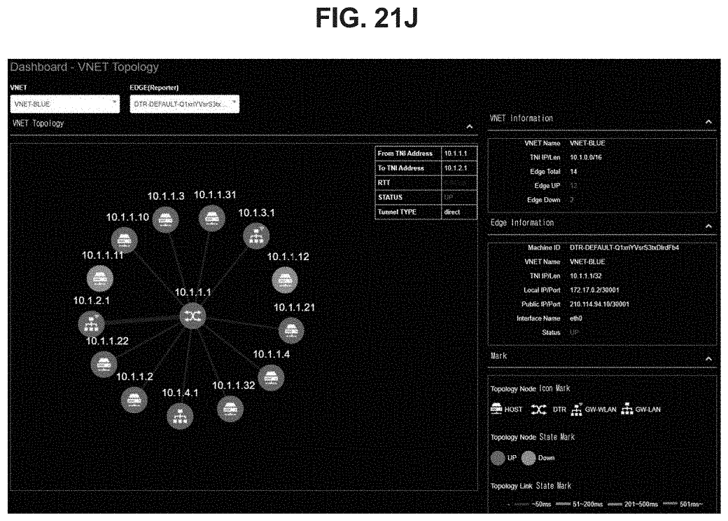

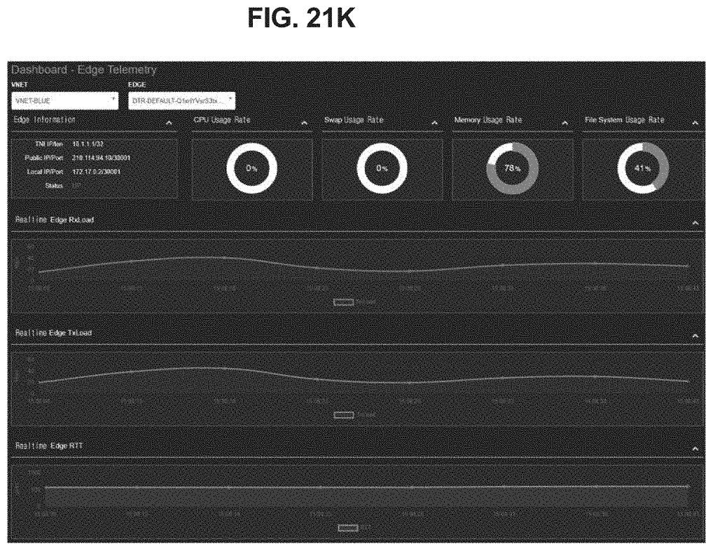

The orchestrator may perform user registration, virtual network registration, edge node registration, etc. and provide and store, to and in a DB, information input for user registration, virtual network registration, edge node registration, etc. For example, the orchestrator may provide user interfaces shown in FIGS. 21a to 21h, and a user may input user information, virtual network information, edge node information, etc. through the corresponding user interface. In response thereto, the orchestrator may perform user registration, virtual network registration, edge node registration, etc. based on the information input through the corresponding user interface. For example, FIG. 21a shows an interface for registering user information, FIGS. 21b and 21c show an interface for registering a host device, FIG. 21d shows an interface for registering a virtual network, and FIGS. 21e to 21h show an interface for registering an edge node.

In addition, the orchestrator may transmit the information input for user registration, virtual network registration, edge node registration, etc. to the controller using “REST API”.

The controller manages information on the edge node received from the orchestrator, performs a “NAT Traversal” function with each edge node, and distributes information on each edge node included in a virtual network. Each edge node may store and manage IP information of the controller, Port information and setting values such as “Key” and “IV” values for encryption as information necessary for operation.

Since the edge node may be connected to a public network, a firewall, NAT, etc., the edge node may perform the “NAT Traversal” function through transmission and reception of messages to and from the controller and receive information on other edge nodes participating in the virtual network from the controller. When the operation type between edge nodes is “Open”, the edge node performs “UDP Hole Punching” operation to set the “Direct Tunnel”. In this case, when setting of “Direct Tunnel” fails in “UDP Hole Punching” operation, the edge node sets the “Detour Tunnel” using “DTR”. The set IP-UDP-IP tunnel performs Encryption and Decryption functions, to which “AES 256” encryption applies, in the Encapsulation and Decapsulation process and provides the encryption function of a data channel.

The edge node periodically transmits system resource information such as traffic, CPU or memory and RTT information between edge nodes. The controller may reflect it to the orchestrator and the DB through “REST API”. In addition, the orchestrator may visualize and provide system resource information such as traffic, CPU or memory.

For example, the controller may configure a topology based on the RTT value between the edge nodes received from the edge node and provide it to the orchestrator and the DB through the REST API. Therefore, the orchestrator may provide information on the edge node, information on the topology and network quality information. For example, the orchestrator may provide the information on the edge node as shown in FIG. 21i, provide the information on the topology as shown in FIG. 21j, and provide the network quality information as shown in FIG. 21k.

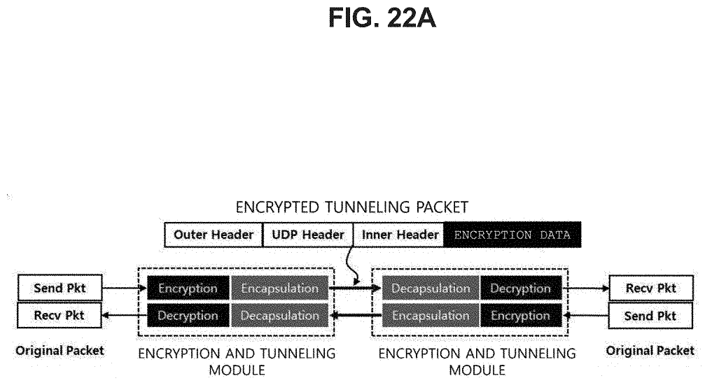

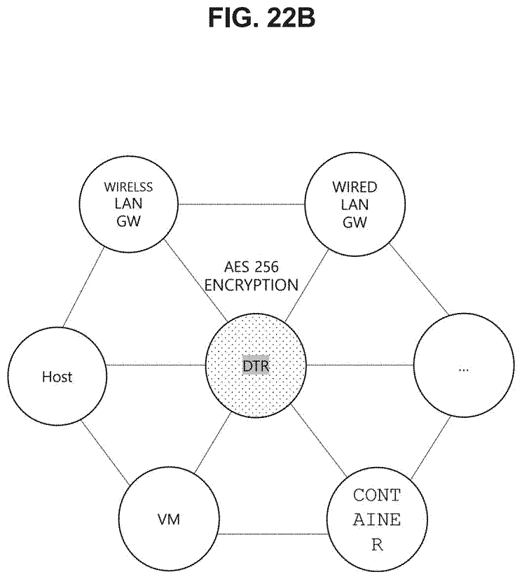

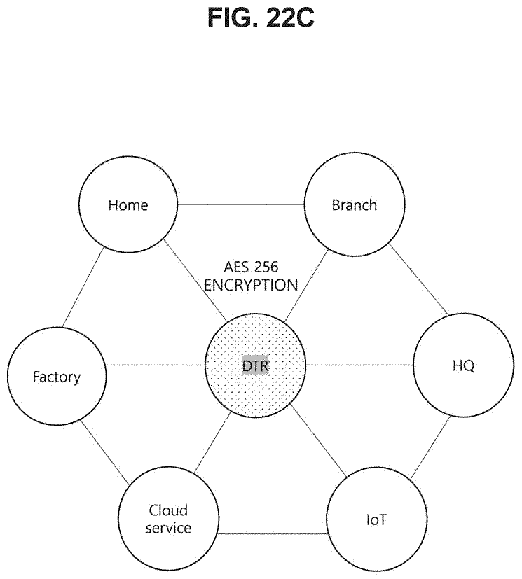

FIG. 22a is a view illustrating encrypted tunneling in a virtual network according to an embodiment of the present disclosure.

An IP-UDP-IP tunnel used in an embodiment of the present disclosure may support encryption. A key and IV used for encryption may be set when a user creates a virtual network, and copy and use this value in setting information necessary when each edge node is connected to the virtual network. A datagram of a packet input to an edge node is subjected to AES 246 encryption using the key and IV value predefined in an S/W module as parameters, a tunnel table is searched and an outer header and a UDP header are encapsulated to transmit a packet to a WAN section. An edge node which receives the encrypted packet decapsulates the outer header, decrypts the encrypted datagram and transmits it to a destination. A reverse packet thereof is subjected to the same procedure to provide an encrypted tunneling function.

FIG. 22b is a view illustrating a virtual network structure according to an embodiment of the present disclosure.

By applying an encryption function to tunneling, it is possible to provide a security networking function between edge nodes. Referring to FIG. 21b, an edge node may be set as various devices. For example, the edge node may be a “Wired LAN G/W” having a LAN, such as an enterprise gateway, a “Wireless LAN G/W” such as an access point, which is used at home or office, or a host, VM or container which does not have a LAN and is an end point. Such edge nodes may transmit and receive data by performing encryption according AES 256 encryption.

In addition, this is applicable to various areas through an encryption tunnel based virtual network structure. For example, referring to FIG. 22c, the encryption tunnel based virtual network is applicable in connection with home, office, branch, headquarter, factory, IoT, cloud service, etc.

A virtual network setting method according to an embodiment of the present disclosure may be performed by a computing system.

The computing system may include at least one processor, memory, user interface input device, user interface output device, storage and network interface connected through a bus.

The processor may be a central processing unit (CPU) or a semiconductor device for processing instructions stored in a memory and/or a storage. The memory and the storage may include various types of volatile or non-volatile storage mediums. For example, the memory may include a read only memory (ROM) and a random access memory (RAM).

Accordingly, steps of a method or algorithm described in connection with the embodiments of the present disclosure may be directly implemented by hardware executed by the processor, a software module or a combination thereof. The software module may reside in a storage medium (that is, a memory and/or a storage) such as a RAM, a flash memory, a ROM, an EPROM, an EEPROM, a register, a hard disk, a removable disk, a CD-ROM. An exemplary storage medium is coupled to the processor, and the processor may read information from the storage medium and write information in the storage medium. As another method, the storage medium may be integral with the processor. The processor and the storage medium may reside in an application specific integrated circuit (ASIC). The ASIC may reside in a user terminal. As another method, the processor and the storage medium may reside in a user terminal as an individual component.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

1. A method of setting a virtual network, the method comprising:
configuring a virtual network including a controller, at least one network address translation (NAT) and at least one edge node;
checking an operation type of the at least one edge node;
setting a tunnel between the at least one edge node based on the operation type; and
performing data transmission between the at least one edge node through the set tunnel.

2. The method of claim 1, wherein the checking the operation type comprises:
generating fake IP information and port information different from IP information and port information assigned to the controller; and
the controller transmitting, to the at least one edge node, a control message in which the fake IP information and port information are set as a source IP and port.

3. The method of claim 2, wherein the checking the operation type comprises:
transmitting the control message to a first edge node through a first NAT;
transmitting the control message to a second edge node through a second NAT;
setting the first edge node, which receives the control message, to a first operation type; and
setting the second edge node, which does not receive the control message, to a second operation type.

4. The method of claim 3, wherein the checking the operation type comprises the controller checking information on the first operation type of the first edge node and information on the second operation type of the second edge node and providing the information to the at least one edge node.

5. The method of claim 4, wherein the setting the tunnel between the at least one edge node comprises the second edge node requesting direct tunnel setting from the first edge node.

6. The method of claim 4, wherein the setting the tunnel between the at least one edge node comprises performing UDP Hole Punching operation.

7. The method of claim 5, comprising completing setting of a direct tunnel between the second edge node and the first edge node, as the second edge node succeeds in setting the direct tunnel to the first edge node.

8. The method of claim 5, comprising setting a detour tunnel between the second edge node and the first edge node, as the second edge node fails in setting the direct tunnel to the first edge node.

9. The method of claim 8, wherein the setting the detour tunnel comprises setting a designated tunnel router as a detour tunnel.

10. The method of claim 1, wherein the configuring the virtual network comprises:
exchanging the control message between the controller and the at least one edge node; and
checking NAT traversal information.

11. The method of claim 10, wherein the NAT traversal information is set for the at least one edge node and comprises at least one of TNI information, local IP information, local port information, public IP information, public port information, connection type information or operation type information.

12. The method of claim 1, wherein the at least one edge node comprises at least one of a host device, a virtual machine (VM) device, or a container device.

13. The method of claim 1, wherein the at least one edge node comprises a network device having a wired LAN, a network device having a wireless LAN, a host device, a virtual machine (VM) device or a container device.

14. The method claim 1, wherein the configuring the virtual network comprises registering user information through an interface configured to register the user information.

15. The method of claim 1, wherein the configuring the virtual network comprises registering host device information through an interface configured to register the host device information.

16. The method of claim 1, wherein the configuring the virtual network comprises registering edge node information through an interface configured to register the edge node information.

17. The method of claim 10, wherein, in performing data transmission between the at least one edge node through the set tunnel, a tunneling packet including external IP header information, external UDP header information, tunnel header information, internal IP header information and a data field is used.

18. The method of claim 17, wherein the external IP header information is set based on local IP information and local port information of the at least one edge node included in the NAT traversal information.

19. The method of claim 17, wherein the internal IP header information comprises virtual IP information and virtual port information set by an orchestrator.
